(19) United States
(12) Patent Application Publication
(10) Pub. No.: US 2026/0024105 A1
(43) Pub. Date: Jan. 22, 2026

(54) ARTIFICIAL INTELLIGENCE-BASED SYSTEMS AND METHODS FOR OPTIMIZING MARKETING OUTCOMES IN A MARKETING PLATFORM

(71) Applicant: Francis Kanneh, Santa Monica, CA (US)

(72) Inventor: Francis Kanneh, Santa Monica, CA (US)

(73) Assignee: Francis Kanneh, Santa Monica, CA (US)

(21) Appl. No.: 18/779,120

(22) Filed: Jul. 22, 2024

(51) Int. Cl. G06Q 30/0202; G06F 16/25

(52) U.S. Cl. CPC G06Q 30/0202; G06F 16/254

(57) ABSTRACT

Disclosed are a system and method for optimizing marketing outcomes in a marketing platform. The method includes a step of obtaining, from a remote server, data. The remote server is configured to receive the data from various data sources. The method includes a step of integrating, by the remote server, the data in a database associated with a marketing platform. The marketing platform includes various marketing mix models (MMMs). The method includes a step of retrieving a structured dataset from the database and mapping it to a scenario template. Each scenario template is associated with a respective machine learning model. The method includes a step of updating, by the respective machine learning model, the marketing mix models (MMMs) using the structured dataset. The method includes a step of forecasting, by a predictive analytics module, an impact of a plurality of future marketing activities, and providing the optimizing marketing outcomes.

### TECHNOLOGICAL FIELD

The present disclosure generally relates to an artificial intelligence (AI) powered platform for marketing mix modeling (MMM) and more particularly relates to a method and a system for optimizing marketing outcomes in a marketing platform.

### BACKGROUND

Marketing Mix Modeling (MMM) is a well-established analytical technique used by marketers to evaluate the effectiveness of various marketing activities on sales performance and other critical business metrics. Traditional MMM approaches, while effective, often come with significant limitations. These conventional methods are typically static, relying heavily on manual processes for data integration and model updates. This manual intervention not only consumes substantial time but also increases the likelihood of errors, which can undermine the accuracy and reliability of the modeling outcomes.

The static nature of traditional MMM presents another challenge: the models quickly become outdated in dynamic market environments where consumer behavior and competitive actions are continually evolving. As a result, marketers using these traditional methods may struggle to keep their strategies aligned with the latest market trends, leading to suboptimal decision-making and missed opportunities.

The present invention seeks to address these critical limitations by introducing an AI-powered platform for Marketing Mix Modeling. By leveraging advanced machine learning techniques and predictive analytics, the present system automates the process of model building and updating. This automation of the present system significantly reduces the time and effort required to maintain accurate and up-to-date models, ensuring that the analytical insights remain relevant and reliable.

Further limitations and disadvantages of conventional approaches will become apparent to one of skill in the art through the comparison of described systems with some aspects of the present disclosure, as outlined in the remainder of the present application and with reference to the drawings.

### BRIEF SUMMARY OF SOME EXAMPLE EMBODIMENTS

In order to solve the foregoing problem, the present disclosure may provide AI-powered marketing mix modeling with predictive analytics.

A method, and a system are provided for an artificial intelligence (AI) powered platform for Marketing Mix Modeling (MMM) that uses machine learning and predictive analytics to optimize marketing strategies.

In one aspect, a method for optimizing marketing outcomes in a marketing platform is provided. The method includes a step of obtaining, from a remote server, data. The remote server is configured to receive the data from various data sources. The method includes a step of integrating, by the remote server, the data in a database associated with a marketing platform. The marketing platform includes various marketing mix models (MMMs). The method includes a step of ingesting the data by using a plurality of ETL (Extract, Transform, Load) processes from the database to obtain a dataset. The dataset is stored in the database. The method includes a step of updating, by a plurality of machine learning models, the marketing mix models (MMMs) using the dataset. The method includes a step of forecasting, by a predictive analytics module, an impact of future marketing activities, and providing the optimizing marketing outcomes.

In additional method embodiments, the method includes a step of enabling, by a natural language processing (NLP) module, a user to query the marketing platform using a natural language to obtain a marketing insight.

In additional method embodiments, the method includes a step of forecasting, by the predictive analytics module, a plurality of marketing outcomes. The predictive analytics module is configured to simulate a plurality of marketing scenarios.

In additional method embodiments, the method includes a step of allowing, by a scenario planning tool, the user to input a plurality of marketing strategies and present one or more projected marketing outcomes using historical data and predictive analytics.

In additional method embodiments, the method includes a step of ensuring, by a data security module, compliance with various data privacy regulations and implementing robust data security measures to protect the dataset.

In yet another aspect, a system to optimize marketing outcomes in a marketing platform is provided. The system includes a memory and a computer processor. The memory is configured for storing program instructions, a plurality of machine learning models, and data. The computer processor is coupled to the memory and executing the program instructions for executing a method includes a step of obtaining data from a remote server. The remote server is configured to receive the data from various data sources. The method includes a step of integrating the data in a database associated with a marketing platform. The marketing platform comprises a plurality of marketing mix models (MMMs). The method includes a step of ingesting the data by using a plurality of ETL (Extract, Transform, Load) processes from the database to obtain a dataset, wherein the dataset is stored in the database. The method includes a step of updating the marketing mix models (MMMs) using the dataset by the machine learning models. The method includes a step of forecasting the impact of a plurality of future marketing activities and providing the optimizing marketing outcomes by a predictive analytics module.

In additional system embodiments, the memory includes a natural language processing (NLP) module configured to enable a user to query the marketing platform using a natural language to obtain marketing insight.

In additional system embodiments, the predictive analytics module is configured to forecast a plurality of marketing outcomes.

In additional system embodiments, the memory includes a scenario planning tool configured to allow the user to input a plurality of marketing strategies and present one or more projected marketing outcomes using historical data and predictive analytics.

In additional system embodiments, the memory includes a data security module configured to ensure compliance with a plurality of data privacy regulations and implement robust data security measures to protect the dataset.

Accordingly, one advantage of the present invention is that it leverages machine learning and predictive analytics to enhance and optimize marketing strategies.

Accordingly, one advantage of the present invention is that it enables marketers to make informed, data-driven decisions, ultimately leading to more effective and efficient marketing strategies that drive optimal outcomes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a system to optimize marketing outcomes in a marketing platform, in accordance with one or more example embodiments.

FIG. 2 illustrates an exemplary block diagram of the system, in accordance with one or more example embodiments.

FIG. 3 illustrates a flowchart of a method for optimizing marketing outcomes in a marketing platform, in accordance with one or more example embodiments.

FIG. 4 illustrates a flowchart of the method for automated model building and updating process using machine learning algorithms, in accordance with one or more example embodiments.

FIG. 5 illustrates a flowchart of a NLP query process, demonstrating how users interact with the system to obtain insights, in accordance with one or more example embodiments.

FIG. 6 illustrates an exemplary flowchart of the scenario planning tool, showing how different marketing strategies are input and projected outcomes are generated, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the purpose of the description and should not be regarded as limiting. Any heading utilized within this description is for convenience only and has no legal or limiting effect.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

A system, a method, and a computer program product are provided for Marketing Mix Modeling (MMM), leveraging machine learning and predictive analytics to enhance and optimize marketing strategies. The system and method include various features for optimizing marketing strategies such as an automated model that simplifies the process of creating and maintaining marketing models, ensuring they remain current and accurate over time. This eliminates the manual effort typically required for model updates, allowing marketers to focus on strategic decision-making. The system also provides customizable dashboards that facilitate marketers with tailored views of their data, enabling easy interpretation and analysis of marketing performance metrics. By customizing the dashboards, users can highlight the most relevant information, facilitating quicker insights and more informed decisions. Another significant feature of the present invention is to integration of Natural Language Processing (NLP) that allows users to query data using everyday language, making data analysis accessible to non-technical users. With NLP, marketers can easily extract insights without needing to learn complex query languages, broadening the platform's usability. The system also provides a scenario planning tool that enables marketers to run “what-if” scenarios, helping them anticipate the impact of various marketing tactics and budget allocations. This predictive capability allows for better foresight and strategic planning, helping to optimize marketing outcomes. The system also provides collaboration tools that facilitate teamwork and information sharing among stakeholders, ensuring that everyone involved in the marketing process is aligned and informed. Enhanced collaboration leads to more cohesive strategies and more effective execution. Finally, the system provides the users with robust compliance and data privacy measures. It ensures that sensitive information is protected and that the platform adheres to regulatory standards. This focus on data privacy and compliance is crucial in today's environment, where data security is paramount.

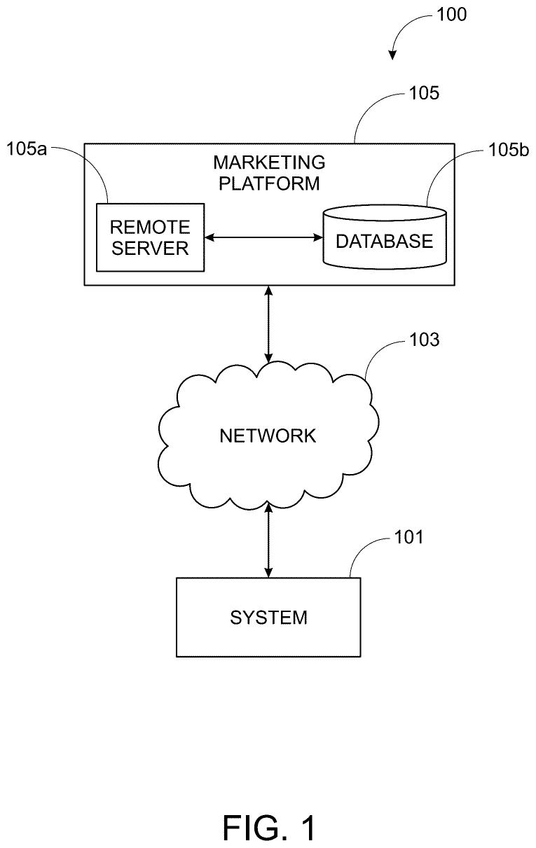

FIG. 1 illustrates a block diagram 100 showing an example architecture of a system 101 to optimize marketing outcomes in a marketing platform, in accordance with one or more example embodiments. As illustrated in FIG. 1, the block diagram 100 may comprise the system 101, a network 103, and a marketing platform 105. The marketing platform 105 includes a remote server 105a, and a database 105b. The components described in the block diagram 100 may be further broken down into more than one component such as one or more modules or applications and/or combined in any suitable arrangement. Further, it is possible that one or more components may be rearranged, changed, added, and/or removed without deviating from the scope of the present disclosure.

In various embodiments, the remote server 105a may receive the data from various data sources such as online channels, offline channels, social media, and CRM systems over the network 103. For example, the system 101 may be embodied as a cloud-based service, a cloud-based application, a cloud-based platform, a remote server-based service, a remote server-based application, a remote server-based platform, or a virtual computing system. In each of such embodiments, the system 101 may be communicatively coupled to the components shown in FIG. 1 to carry out the desired operations and wherever required modifications may be possible within the scope of the present disclosure.

In various embodiments, the system 101, database 105b, and the remote server 105a are connected over the network 103 for data transmission. The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The database 105b may include data received from the online channels, offline channels, social media, and CRM systems. The database 105b may be communicatively coupled to the remote server 105a. The remote server 105a may comprise one or more processors configured to process requests received from the system 101. The processor may fetch data from the database 105b and transmit the same to the system 101 in a format suitable for use by the system 101.

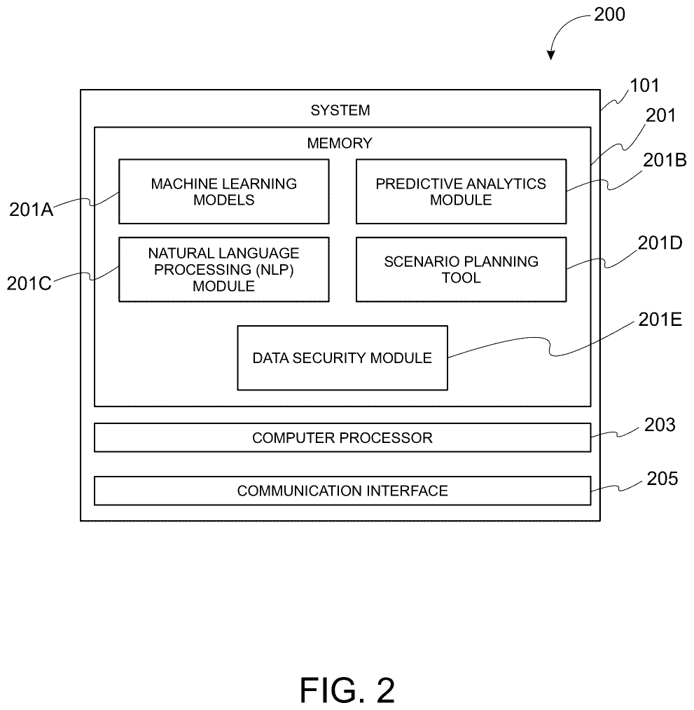

FIG. 2 illustrates an exemplary block diagram 200 of the system 101, in accordance with one or more example embodiments. FIG. 2 is explained in conjunction with FIG. 1. The system 101 includes a memory 201, a computer processor 203, and a communication interface 205. Memory 201 is configured for storing program instructions, a plurality of machine learning models 201A, and data. In an embodiment, the memory 201 is further configured for storing a predictive analytics module 201B, a natural language processing (NLP) module 201C, a scenario planning tool 201D, and a data security module 201E. The computer processor 203 is coupled to the memory 201 and executes the program instructions for executing a method that includes a step of obtaining data from the remote server 105a. The remote server 105a is configured to receive the data from various data sources. Examples of the data sources include but are not limited to online channels, offline channels (e.g. TV, radio, print media), social media platforms (e.g. Twitter, Instagram, YouTube), Customer Relationship Management (CRM) systems (e.g. Salesforce, HubSpot), Digital Marketing Platforms (e.g. Google Ads, Facebook Ads, LinkedIn Ads), e-commerce platforms (e.g. Shopify, WooCommerce), and email marketing tools (e.g. Mailchimp, SendGrid). The method includes a step of integrating the data in database 105b associated with the marketing platform 105. The marketing platform 105 includes various marketing mix models (MMMs). The method includes a step of ingesting the data by using ETL (Extract, Transform, Load) processes from database 105b to obtain a dataset, wherein the dataset is stored in database 105b. The method includes a step of updating the marketing mix models (MMMs) using the dataset by the machine learning model 201A. The method includes a step of forecasting the impact of various future marketing activities and providing the optimizing marketing outcomes by a predictive analytics module 201B. In an embodiment, the predictive analytics module 201B is configured to forecast a plurality of marketing outcomes.

In an embodiment, the natural language processing (NLP) module 201C is configured to enable a user to query the marketing platform using a natural language to obtain marketing insight. In an embodiment, the scenario planning tool 201D is configured to allow the user to input various marketing strategies and present projected marketing outcomes using historical data and predictive analytics. In an embodiment, the data security module 201E is configured to ensure compliance with a plurality of data privacy regulations and implement robust data security measures to protect the dataset.

According to some embodiments, each of the components and modules 201A-201E may be embodied in the memory 201. The computer processor 203 may retrieve computer program code instructions that may be stored in the memory 201 for the execution of computer program code instructions, which may be configured to facilitate data-driven decisions and achieve optimal marketing outcomes. In an embodiment, the computer processor 203 is configured to perform data cleaning and preprocessing to ensure high-quality input for the machine learning models 201A. Data cleaning and preprocessing methods include automated checks for missing, duplicate, or inconsistent data through data validation, normalization and standardization of data formats via data transformation, and the creation of new features from raw data to enhance model performance through feature engineering. Additionally, outlier detection is employed to identify and handle outliers, and data integration combines data from various sources into a unified dataset.

The machine learning models 201A are designed to automatically construct and update marketing mix models. These models continuously learn from new data inputs, ensuring that the insights they provide remain up-to-date and relevant. The system 101 is capable of handling a wide variety of data sources, including online and offline channels, social media platforms, CRM systems, and more, allowing for a comprehensive analysis of marketing activities. In an embodiment, the machine learning models 201A are configured to use various machine learning algorithms to enhance marketing mix modeling. Examples of machine learning algorithms include but are not limited to linear regression, random forests, Gradient Boosting Machines (GBM), and neural networks. Linear Regression is employed for basic correlation analysis between marketing activities and sales, providing straightforward insights into direct relationships. Random Forests are used to manage non-linear relationships and interactions between multiple variables, offering a more nuanced understanding of complex marketing dynamics. Gradient Boosting Machines (GBM) are implemented to improve model accuracy through boosting techniques, ensuring more reliable predictions. Neural Networks are utilized for complex pattern recognition and forecasting, particularly in large datasets, allowing for sophisticated analysis and predictions of marketing outcomes.

In an embodiment, the machine learning models 201A require various types of data inputs to function effectively. These include historical sales data, which provides a foundation for analyzing past performance, and marketing spend data, detailing budget allocation across various channels such as TV, online, and print. Customer data, encompassing demographic information and purchasing behavior, is essential for understanding target audiences. Media data, such as ad impressions, click-through rates, and reach, offers insights into the effectiveness of advertising efforts. Economic indicators like inflation rates, GDP, and the consumer confidence index provide context for market conditions. Additionally, competitor data, including market share and details of competitor campaigns, helps in benchmarking and strategic planning.

The predictive analytics module 201B leverages advanced analytics to forecast the potential impacts of future marketing activities. By simulating different marketing scenarios, this module offers recommendations on the optimal mix of marketing efforts needed to achieve specific business objectives. The predictive models are continuously refined using historical data and current market trends, enhancing their accuracy and reliability over time. In an embodiment, the potential impacts of future marketing activities are forecasted using various methods, including time series analysis, machine learning models, scenario simulation, and What-If analysis. Time series analysis employs ARIMA (AutoRegressive Integrated Moving Average) models to identify patterns and trends in historical data. Machine learning models, such as LSTM (Long Short-Term Memory), are used to handle sequential data and predict future outcomes. Scenario simulation involves creating hypothetical scenarios based on historical data trends and current market conditions to explore different possibilities. What-If analysis assesses the potential outcomes of various marketing strategies, allowing marketers to evaluate the effectiveness of their plans before implementation.

In an embodiment, the predictive analytics module 201B is configured to optimize marketing activities by using an optimization and feedback loop from actual outcomes to improve predictions. The optimization and feedback loop recommends optimal distribution of the marketing budget across channels. Further, the optimization and feedback loop identify the most effective channels and tactics. Then, the optimization and feedback loop fed back the actual outcomes into the system to update and refine models. Lastly, optimization and feedback loop track the campaign performance to adjust strategies dynamically in real time.

The natural language processing (NLP) module 201C enables users to interact with the system using natural language queries. This feature simplifies data interaction, making it accessible to users without deep technical expertise. For instance, users can ask questions such as, “What is the impact of our social media campaigns on sales?” and receive detailed, easy-to-understand responses, facilitating better decision-making.

The scenario planning tool 201D allows users to perform scenario planning by inputting different marketing strategies and viewing the projected outcomes. This tool uses historical data and predictive analytics to generate actionable insights for future marketing plans. By providing a clear visualization of potential results, it helps marketers make well-informed decisions and optimize their strategies.

In operation, different marketing strategies are simulated within the scenario planning tool by following a structured process. Users first input historical marketing and sales data, providing a foundation for analysis. They then define parameters for various strategies, such as increased budget or the introduction of new channels. Predictive models run simulations to project the impact of these strategies. Finally, the tool compares the projected outcomes against key metrics like sales, ROI, and customer acquisition, allowing users to evaluate the effectiveness of each strategy and make informed decisions.

The data security module 201E ensures compliance with data privacy regulations such as GDPR and CCPA. This module implements robust data security measures to protect sensitive marketing data, giving users confidence in the platform's integrity and its ability to safeguard their information. The data security module 201E implements various data security measures to ensure robust protection of sensitive information. These measures include data encryption at rest and in transit using SSL/TLS, and role-based access control (RBAC) to restrict data access. Regular audits are conducted to ensure compliance with GDPR, CCPA, and other data privacy regulations. Additionally, data anonymization techniques are employed to safeguard sensitive information, and secure APIs are used for data integration and processing, ensuring comprehensive data security.

The computer processor 203 may be embodied in a number of different ways. For example, the computer processor 203 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the computer processor 203 may include one or more processing cores configured to perform independently. A multi-core processor may enable multiprocessing within a single physical package. Additionally, or alternatively, the computer processor 203 may include one or more processors configured in tandem via the bus to enable independent execution of instructions, pipelining, and/or multithreading.

Additionally, or alternatively, the computer processor 203 may include one or more processors capable of processing large volumes of workloads and operations to provide support for big data analysis. In an example embodiment, the computer processor 203 may be in communication with the memory 201 via a bus for passing information to system 101. The memory 201 may be non-transitory and may include, for example, one or more volatile and/or non-volatile memories. In other words, for example, the memory 201 may be an electronic storage device (for example, a computer-readable storage medium) comprising gates configured to store data (for example, bits) that may be retrievable by a machine (for example, a computing device like the computer processor 203). The memory 201 may be configured to store information, data, content, applications, instructions, or the like, to enable the computer processor 203 to carry out various functions in accordance with an example embodiment of the present disclosure. For example, the memory 201 may be configured to buffer input data for processing by the computer processor 203. As exemplarily illustrated in FIG. 2, the memory 201 may be configured to store instructions for execution by the computer processor 203. As such, whether configured by hardware or software methods, or by a combination thereof, the computer processor 203 may represent an entity (for example, physically embodied in circuitry) capable of performing operations according to an embodiment of the present disclosure while configured accordingly. Thus, for example, when the computer processor 203 is embodied as an ASIC, FPGA, or the like, the computer processor 203 may be specifically configured hardware for conducting the operations described herein. Alternatively, as another example, when the computer processor 203 is embodied as an executor of software instructions, the instructions may specifically configure the computer processor 203 to perform the algorithms and/or operations described herein when the instructions are executed. However, in some cases, the computer processor 203 may be a processor-specific device (for example, a mobile terminal or a fixed computing device) configured to employ an embodiment of the present disclosure by further configuration of the computer processor 203 by instructions for performing the algorithms and/or operations described herein. The computer processor 203 may include, among other things, a clock, an arithmetic logic unit (ALU), and logic gates configured to support the operation of the computer processor 203.

The system 101 may be accessed using the communication interface 205. The communication interface 205 may provide an interface for accessing various features and data stored in the system 101. For example, the communication interface 205 may comprise an I/O interface which may be in the form of a GUI, a touch interface, a voice-enabled interface, a keypad, and the like. In an embodiment, the communication interface 205 may present visual reports or dashboards based on insights and forecasts. Users can create and customize dashboards with various widgets and visualizations, which are updated in real time with the latest data. Interactive visualizations such as charts, graphs, and tables display insights and forecasts. Additionally, the system offers export options to various formats like PDF, Excel, and PowerPoint. Dashboards can be shared with team members, with features for annotations and comments to facilitate sharing and collaboration.

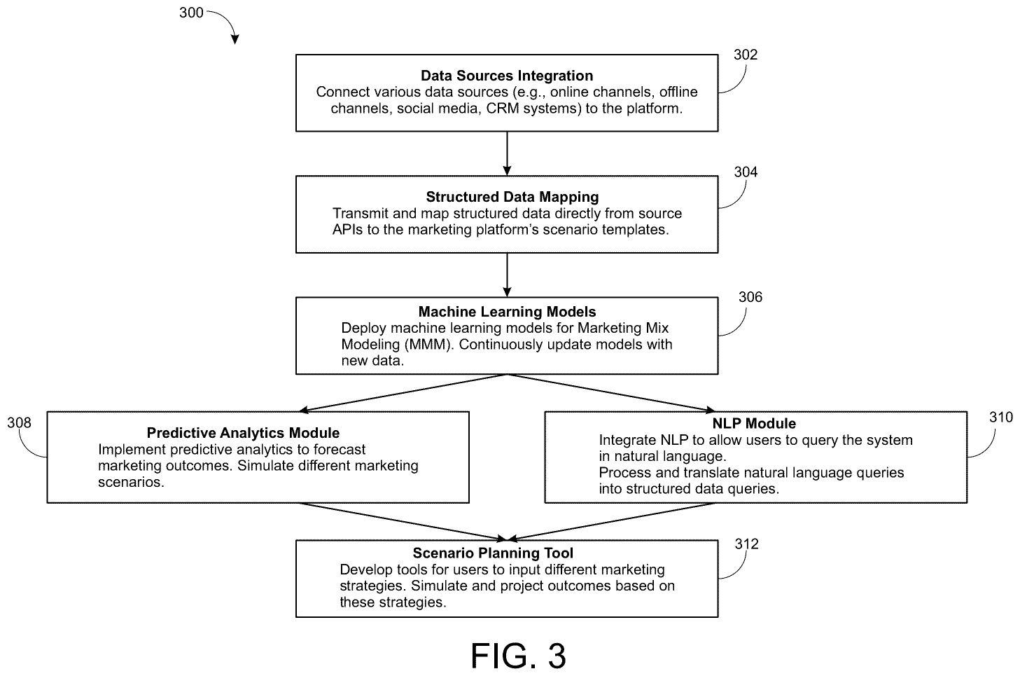

FIG. 3 illustrates a flowchart of a method 300 for optimizing marketing outcomes in a marketing platform, in accordance with one or more example embodiments. FIG. 3 is explained in conjunction with FIG. 1. The method 300 includes a step 302 of obtaining data from a remote server. The remote server is configured to receive the data from various data sources. The remote server data then integrates the data in a database associated with a marketing platform. The marketing platform includes various marketing mix models (MMMs). The method 300 includes a step 302 of ingesting the data by using ETL (Extract, Transform, Load) processes from the database to obtain a dataset. The dataset is stored in the database. Examples of the database include but are not limited to data lakes, data warehouses, and relational databases. In an embodiment, the data lake is a centralized repository that allows the user or administrator to store all the structured and unstructured datasets at any scale. The dataset can be stored as-is, without having to first structure the data, and run different types of analytics from dashboards and visualizations to big data processing, real-time analytics, and machine learning. In an embodiment, the data warehouse is a centralized repository for storing large volumes of structured data from multiple sources. It is optimized for query performance and analysis. In an embodiment, the relational database is configured to store and provide access to data points that are related to one another. In the relational database, data is organized into tables (relations) that are linked to each other through keys.

The method 300 includes a step 304 of deploying various machine learning models for the marketing mix models (MMMs). The machine learning models are continuously updated with new datasets. The method 300 includes a step 306 of forecasting, by the predictive analytics module, an impact of future marketing activities, and providing the optimizing marketing outcomes. The predictive analytics module is further configured to forecast various marketing outcomes and simulate various marketing scenarios. The method 300 includes a step 308 of enabling, by a natural language processing (NLP) module, a user to query the marketing platform using a natural language to obtain a marketing insight. The method 300 further includes a step 310 of allowing, by a scenario planning tool, the user to input a plurality of marketing strategies and present one or more projected marketing outcomes using historical data and predictive analytics. The method 300 lastly includes a step 314 of ensuring, by a data security module, compliance with various data privacy regulations and implementing robust data security measures to protect the dataset.

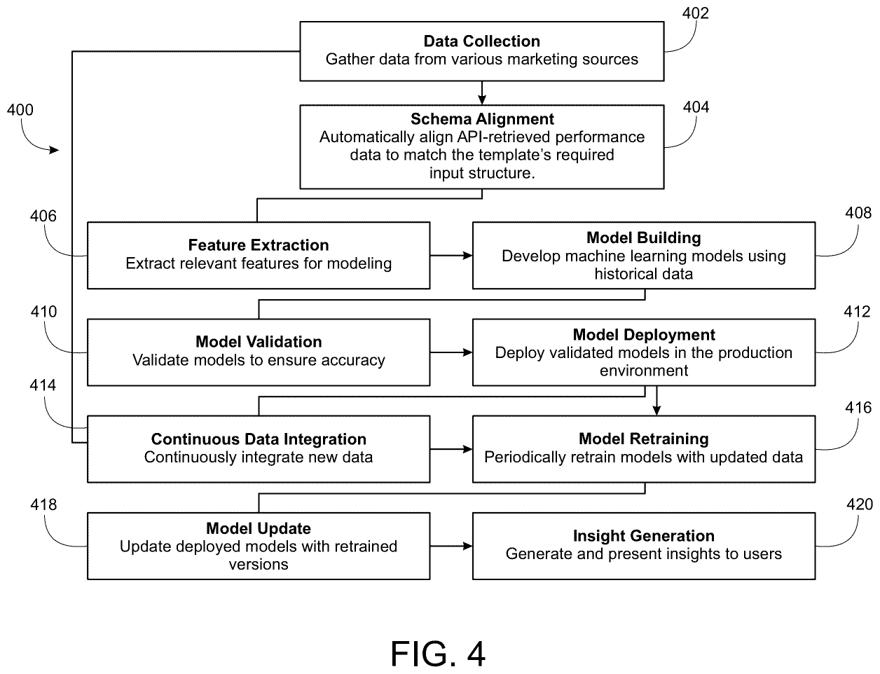

FIG. 4 illustrates a flowchart 400 of the method for automated model building and updating process using machine learning algorithms, in accordance with one or more example embodiments. This method initiates a step 402 of gathering data from various marketing sources, including sales figures, marketing spends, customer demographics, and media metrics. The method then includes a step 404 of cleaning and preprocessing the collected data by validating it, transforming formats, and addressing outliers to ensure high-quality input. At block 406, relevant features are extracted from the preprocessed data that are essential for building effective machine-learning models. Then, at block 408, machine learning models are developed using the historical data, employing algorithms such as linear regression, random forests, and neural networks. At block 410, the models are validated to ensure they are accurate and reliable by testing them against a subset of the data. At block 412, the validated models are deployed into the production environment where they can be used for real-time predictions and analysis. The method then includes a step 414 of continuously integrating new data into the system to keep the models up to date with the latest information. The method then includes a step 416 of periodically retraining the models with the updated data to improve their accuracy and relevance over time. At block 418, the deployed models are updated with the newly retrained versions to maintain optimal performance. The method then includes a step 420 of generating and presenting actionable insights to users based on the model outputs, helping them make data-driven marketing decisions.

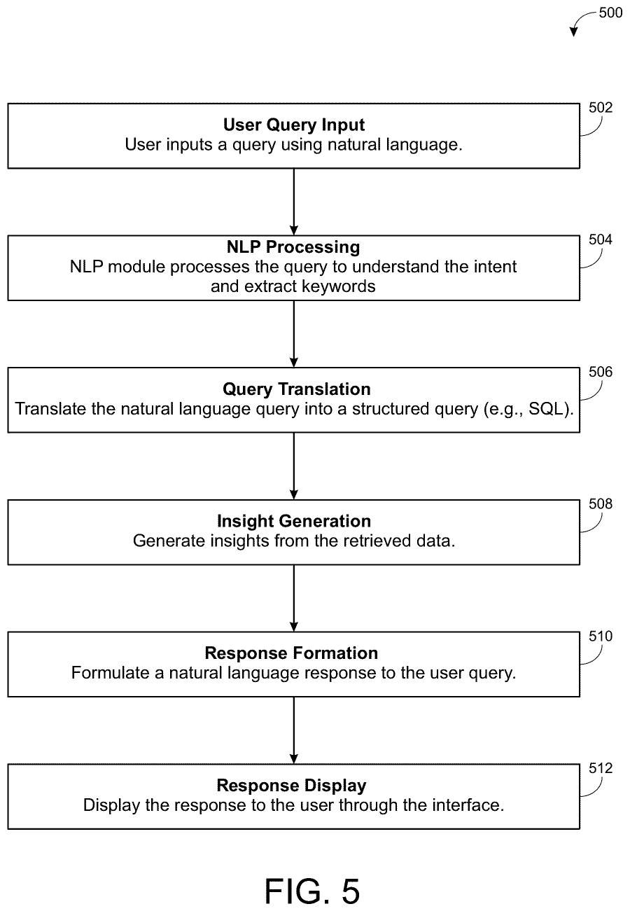

FIG. 5 illustrates a flowchart 500 of a NLP query process, demonstrating how users interact with the system to obtain insights, in accordance with one or more example embodiments. At block 502, the user inputs a query using natural language, such as “What was the impact of our recent social media campaign on sales?” At block 504, the NLP module processes the user query to understand the user's intent and extract relevant keywords and phrases. At block 506, the system translates the natural language query into a structured query format, such as SQL, to facilitate data retrieval. Then the system executes the structured query to retrieve relevant data from the underlying databases or data sources. At block 508, the system analyzes the retrieved data to generate meaningful insights that address the user's query. At block 510, the system formulates a natural language response based on the generated insights, ensuring it is clear and informative. At block 512, the formulated response is displayed to the user through the interface, providing them with the requested insights in an easily understandable format.

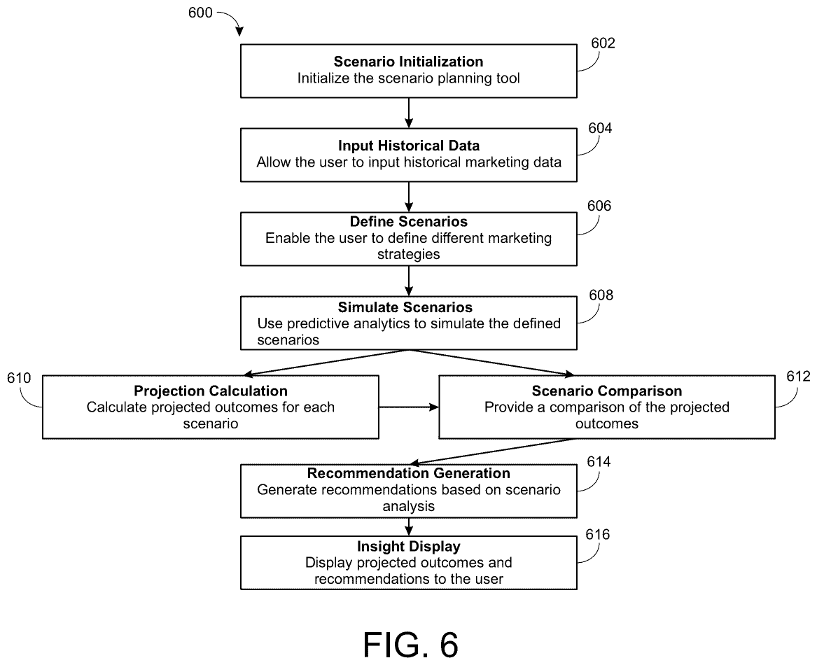

FIG. 6 illustrates an exemplary flowchart of the scenario planning tool, showing how different marketing strategies are input and projected outcomes are generated, in accordance with one or more example embodiments. At block 602, the scenario planning tool is initialized to prepare it for user interaction and data input. At block 604, the user is allowed to input historical marketing data, which serves as the foundation for scenario simulations. At block 606, the user is enabled to define different marketing strategies by specifying various parameters, such as budget allocation, target channels, and campaign timelines. At block 608, predictive analytics is used to simulate the defined scenarios, leveraging historical data and predictive models to forecast potential outcomes. At block 610, projected outcomes are calculated for each scenario, providing estimations for key metrics such as sales, return on investment (ROI), and customer acquisition. At block 612, a comparison of the projected outcomes is provided across different scenarios, allowing the user to see the potential impact of each strategy. At block 614, recommendations are generated based on scenario analysis, suggesting optimal marketing strategies to achieve desired business objectives. At block 616, the projected outcomes and recommendations are displayed to the user through an intuitive interface, enabling data-driven decision-making for marketing strategies.

Thus, the present system and method empower marketers to make informed, data-driven decisions. The advanced capabilities of the platform lead to more effective and efficient marketing strategies, driving optimal outcomes and maximizing the return on marketing investments. By leveraging advanced machine learning techniques and predictive analytics, the platform automates the process of model building and updating. This automation significantly reduces the time and effort required to maintain accurate and up-to-date models, ensuring that the analytical insights remain relevant and reliable. Beyond automation, the platform offers a suite of innovative features designed to enhance marketing decision-making. These features include customizable dashboards that provide tailored views of key performance metrics, making it easier for marketers to interpret and act on data. The incorporation of Natural Language Processing (NLP) allows users to query data using everyday language, democratizing access to advanced analytics and enabling non-technical users to extract valuable insights effortlessly. Scenario planning capabilities within the platform enable marketers to simulate various “what-if” scenarios, helping them predict the potential impact of different marketing strategies and budget allocations. This foresight is crucial for strategic planning and optimizing marketing outcomes. Additionally, collaboration tools facilitate teamwork and information sharing among stakeholders, ensuring alignment and cohesive execution of marketing plans. Importantly, the present system and method are built with robust compliance and data privacy measures, addressing the critical need for data security in today's regulatory landscape. By ensuring that sensitive information is protected and that the platform adheres to regulatory standards, this invention provides a secure environment for marketers to conduct their analysis.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for optimizing marketing outcomes in a marketing platform, comprising:
obtaining, from a remote server, data, wherein the remote server is configured to receive the data from a plurality of data sources;
integrating, by the remote server, the data in a database associated with a marketing platform, wherein the marketing platform comprises a plurality of marketing mix models (MMMs);
retrieving, from the database, a structured dataset for use in forecasting by a respective machine learning model associated with each marketing mix model (MMM);
updating, by the respective machine learning model, the marketing mix models (MMMs) using the structured dataset; and
forecasting, by a predictive analytics module, an impact of a plurality of future marketing activities and providing the optimizing marketing outcomes.

2. The method of claim 1, further comprises: enabling, by a natural language processing (NLP) module, a user to query the marketing platform using a natural language to obtain a marketing insight.

3. The method of claim 1, further comprises: forecasting, by the predictive analytics module, a plurality of marketing outcomes, wherein the predictive analytics module is configured to simulate a plurality of marketing scenarios.

4. The method of claim 1, further comprises: allowing, by a scenario planning tool, the user to input a plurality of marketing strategies and present one or more projected marketing outcomes using historical data and predictive analytics.

5. The method of claim 1, further comprises: ensuring, by a data security module, compliance with a plurality of data privacy regulations and implementing robust data security measures to protect the dataset.

6. A system to optimize marketing outcomes in a marketing platform, comprising:
a memory for storing program instructions, a plurality of marketing mix models (MMMs), and structured data;
a computer processor coupled to the memory and executing the program instructions for executing a method comprising:
obtaining data from a remote server, wherein the remote server is configured to receive the data from a plurality of data sources;
integrating the data in a database associated with a marketing platform, wherein the marketing platform comprises a plurality of marketing mix models (MMMs);
retrieving, from the database, a structured dataset for use by a respective machine learning model associated with each MMM;
updating the marketing mix models (MMMs) using the structured dataset by the respective machine learning model; and
forecasting an impact of a plurality of future marketing activities and providing the optimizing marketing outcomes by a predictive analytics module.

7. The system of claim 6, wherein the memory comprises a natural language processing (NLP) module configured to enable a user to query the marketing platform using a natural language to obtain a marketing insight.

8. The system of claim 6, wherein the predictive analytics module is configured to forecast a plurality of marketing outcomes.

9. The system of claim 6, wherein the memory comprises a scenario planning tool configured to allow the user to input a plurality of marketing strategies and present one or more projected marketing outcomes using historical data and predictive analytics.

10. The system of claim 6, wherein the memory comprises a data security module configured to ensure compliance with a plurality of data privacy regulations and implementing robust data security measures to protect the dataset.
